(19) United States
(12) Patent Application Publication
(10) Pub. No.: US 2010/0106744 A1
(43) Pub. Date: Apr. 29, 2010

(54) CONFLICT PREVENTION FOR PEER-TO-PEER REPLICATION

(75) Inventor: Rui Wang, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/256,473

(22) Filed: Oct. 23, 2008

(51) Int. Cl. G06F 17/30; G06F 7/00; G06F 17/00

(52) U.S. Cl. 707/783; 707/E17.009; 707/E17.005

(57) ABSTRACT

Aspects of the subject matter described herein relate to conflict prevention. In aspects, a peer that seeks to modify a data structure first determines whether it is the owner of the data structure. An owner of the data structure has rights to update the data structure. If the peer is not the owner, the peer sends a request to the owner. The owner responds to the request by changing ownership of the data structure to the peer. Once this change is replicated to the peer, the peer is able to update the data structure as desired.

### BACKGROUND

In a peer-to-peer database replication topology, peers have the same table schema and each row has a replica on each peer. Data manipulations may occur on any peer and will then be replicated to all other peers. Conflicting manipulations such as modifying different replicas of the same row may occur on different peers at the same time. Resolving conflicting manipulations may be difficult, time consuming, or involve significant overhead.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

Briefly, aspects of the subject matter described herein relate to conflict prevention. In aspects, a peer that seeks to modify a data structure first determines whether it is the owner of the data structure. The owner of the data structure has rights to update the data structure. If the peer is not the owner, the peer sends a request to the owner. The owner responds to the request by changing ownership of the data structure to the peer. Once this change is replicated to the peer, the peer is able to update the data structure as desired.

This Summary is provided to briefly identify some aspects of the subject matter that is further described below in the Detailed Description. This Summary is not intended to identify key or essential features of the claimed subject matter, nor is it intended to be used to limit the scope of the claimed subject matter.

The phrase “subject matter described herein” refers to subject matter described in the Detailed Description unless the context clearly indicates otherwise. The term “aspects” is to be read as “at least one aspect.” Identifying aspects of the subject matter described in the Detailed Description is not intended to identify key or essential features of the claimed subject matter.

The aspects described above and other aspects of the subject matter described herein are illustrated by way of example and not limited in the accompanying figures in which like reference numerals indicate similar elements and in which:

### BRIEF DESCRIPTION OF THE DRAWINGS

FIG. 1 is a block diagram representing an exemplary general-purpose computing environment into which aspects of the subject matter described herein may be incorporated;

FIG. 2 is a block diagram representing an exemplary environment in which aspects of the subject matter described herein may be implemented;

FIG. 3 is a block diagram illustrating exemplary actions involved in modifying data in accordance with aspects of the subject matter described herein;

FIG. 4 is a block diagram that represents an apparatus configured as a peer in accordance with aspects of the subject matter described herein;

FIG. 5 is a flow diagram that generally represents actions that may occur on a peer seeking to modify a data structure in accordance with aspects of the subject matter described herein; and

FIG. 6 is a flow diagram that generally represents actions that may occur on a peer receiving a token access request in accordance with aspects of the subject matter described herein.

### DETAILED DESCRIPTION

### Definitions

As used herein, the term “includes” and its variants are to be read as open-ended terms that mean “includes, but is not limited to.” The term “or” is to be read as “and/or” unless the context clearly dictates otherwise. Other definitions, explicit and implicit, may be included below.

### Exemplary Operating Environment

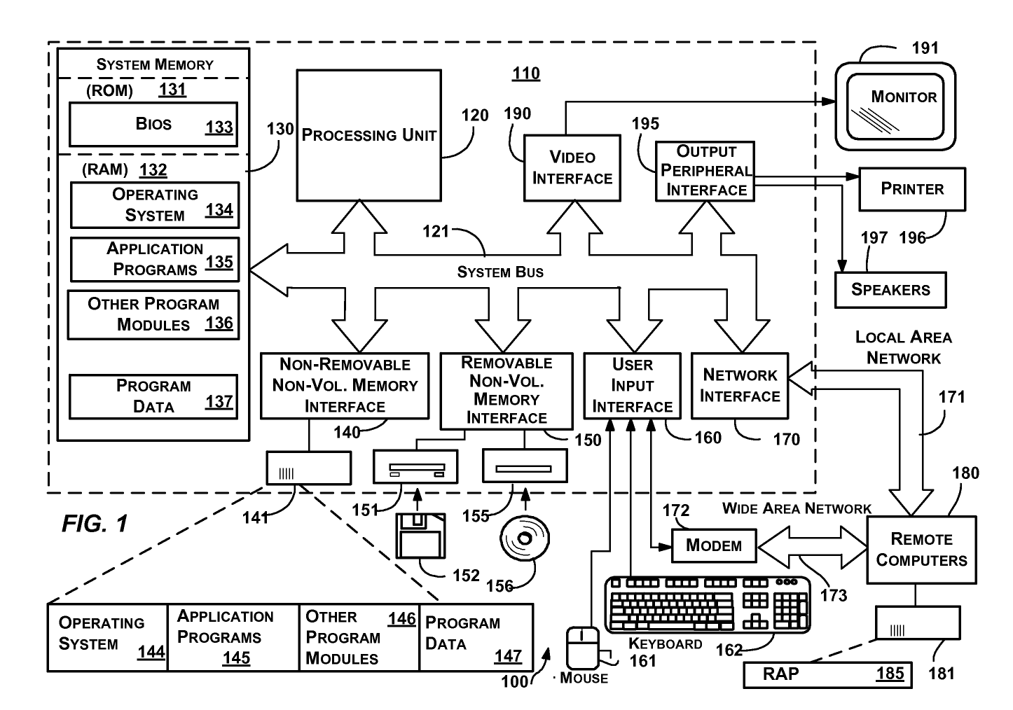

FIG. 1 illustrates an example of a suitable computing system environment 100 on which aspects of the subject matter described herein may be implemented. The computing system environment 100 is only one example of a suitable computing environment and is not intended to suggest any limitation as to the scope of use or functionality of aspects of the subject matter described herein. Neither should the computing environment 100 be interpreted as having any dependency or requirement relating to any one or combination of components illustrated in the exemplary operating environment 100.

Aspects of the subject matter described herein are operational with numerous other general purpose or special purpose computing system environments or configurations. Examples of well known computing systems, environments, or configurations that may be suitable for use with aspects of the subject matter described herein comprise personal computers, server computers, hand-held or laptop devices, multiprocessor systems, microcontroller-based systems, set top boxes, programmable consumer electronics, network PCs, minicomputers, mainframe computers, personal digital assistants (PDAs), gaming devices, printers, appliances including set-top, media center, or other appliances, automobile-embedded or attached computing devices, other mobile devices, distributed computing environments that include any of the above systems or devices, and the like.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing aspects of the subject matter described herein includes a general-purpose computing device in the form of a computer 110. A computer may include any electronic device that is capable of executing an instruction. Components of the computer 110 may include a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, Peripheral Component Interconnect Extended (PCI-X) bus, Advanced Graphics Port (AGP), and PCI express (PCIe).

The computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media.

Computer storage media includes both volatile and nonvolatile, removable and non-removable media implemented in any method or technology for storage of information such as computer-readable instructions, data structures, program modules, or other data. Computer storage media includes RAM, ROM, EEPROM, flash memory or other memory technology, CD-ROM, digital versatile discs (DVDs) or other optical disk storage, magnetic cassettes, magnetic tape, magnetic disk storage or other magnetic storage devices, or any other medium which can be used to store the desired information and which can be accessed by the computer 110.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disc drive 155 that reads from or writes to a removable, nonvolatile optical disc 156 such as a CD ROM or other optical media. Other removable/non-removable, volatile/nonvolatile computer storage media that can be used in the exemplary operating environment include magnetic tape cassettes, flash memory cards, digital versatile discs, other optical discs, digital video tape, solid state RAM, solid state ROM, and the like. The hard disk drive 141 is typically connected to the system bus 121 through a non-removable memory interface such as interface 140, and magnetic disk drive 151 and optical disc drive 155 are typically connected to the system bus 121 by a removable memory interface, such as interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies.

A user may enter commands and information into the computer 20 through input devices such as a keyboard 162 and pointing device 161, commonly referred to as a mouse, trackball, or touch pad. Other input devices (not shown) may include a microphone, joystick, game pad, satellite dish, scanner, a touch-sensitive screen, a writing tablet, or the like. These and other input devices are often connected to the processing unit 120 through a user input interface 160 that is coupled to the system bus, but may be connected by other interface and bus structures, such as a parallel port, game port or a universal serial bus (USB).

A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets, and the Internet.

When used in a LAN networking environment, the computer 110 is connected to the LAN 171 through a network interface or adapter 170. When used in a WAN networking environment, the computer 110 may include a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

### Conflict Prevention

As mentioned previously, in peer-to-peer replication topologies, when different peers concurrently modify replicas of the same data, conflicting updates may occur. Resolving these conflicting update may be difficult, time consuming, or involve significant overhead. Instead of attempting to resolve conflicting updates, a conflict prevention technique may be employed. In a conflict prevention technique, only one peer may update the same data at a time.

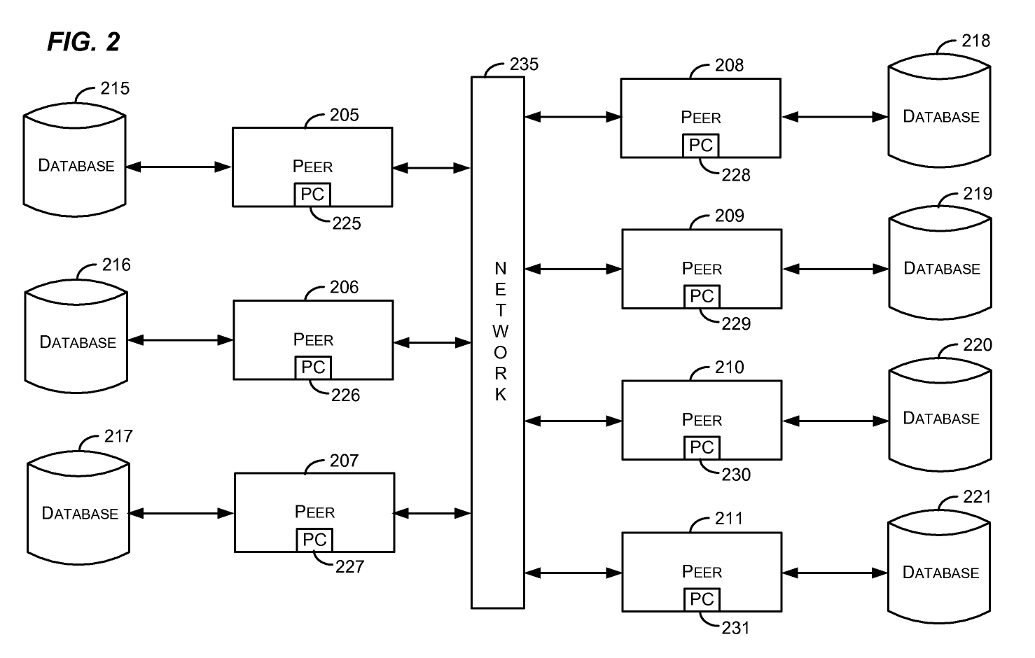

FIG. 2 is a block diagram representing an exemplary environment in which aspects of the subject matter described herein may be implemented. The environment may include various peers 205-211, databases 215-221, a network 235, and may include other entities (not shown). The peers 205-211 may include conflict prevention components 225-231. The various entities may be located relatively close to each other or may be distributed across the world. The various entities may communicate with each other via various networks including intra- and inter-office networks and the network 235.

In an embodiment, the network 235 may comprise the Internet. In an embodiment, the network 235 may comprise one or more local area networks, wide area networks, direct connections, virtual connections, private networks, virtual private networks, some combination of the above, and the like.

Each of the peers 205-211 may be implemented on or as one or more computers (e.g., the computer 110 as described in conjunction with FIG. 1). A peer may comprise one or more processes that request access, either directly or indirectly, to data on a database. As another example, a peer may comprise an application that stores data to and retrieves data from a database via a DBMS that executes on the peer.

The databases 215-221 comprise repositories that are capable of storing data in a structured format. The term data is to be read broadly to include anything that may be stored on a computer storage medium. Some examples of data include information, program code, program state, program data, other data, and the like.

Data stored in the databases 215-221 may be organized in tables, records, objects, other data structures, and the like. The data may be stored in HTML files, XML files, spreadsheets, flat files, document files, and other files. The databases 215-221 may be classified based on a model used to structure the data. For example, the databases 215-221 may comprise a relational database, object-oriented database, hierarchical database, network database, other type of database, some combination or extension of the above, and the like.

The databases 215-221 may be accessed via database management systems (DBMSs). A DBMS may comprise one or more programs that control organization, storage, management, and retrieval of data in a database. A DBMS may receive requests to access data in the database and may perform the operations needed to provide this access. Access as used herein may include reading data, writing data, deleting data, updating data, a combination including one or more of the above, and the like.

The databases 215-221 may be stored on data stores. A data store may comprise any storage media capable of storing data. For example, a data store may comprise a file system, volatile memory such as RAM, other storage media described in conjunction with FIG. 1, other storage, some combination of the above, and the like and may be distributed across multiple devices. The data stores upon which the databases 215-221 are stored may be external, internal, or include components that are both internal and external to the peers 205-211. Similarly, the databases 215-221 and/or DBMSs may be hosted by or separate from the peers 205-211.

The databases 215-221 may participate in a replication system in which data from the databases is replicated across the databases 215-221. For example, in a relational database, each of the databases may have the same schema, and rows of tables may be replicated on each peer.

In describing aspects of the subject matter described herein, for simplicity, terminology associated with relational databases is sometimes used herein. Although relational database terminology is often used herein, the teachings herein may also be applied to other types of databases including those that have been mentioned previously.

To prevent concurrent updates of replicas of a row of a database, the table that includes the row may be extended to include a hidden column. For a row in the table, a field corresponding to this hidden column may include an identifier that identifies the peer who “owns” the row. This field is sometimes referred to herein as the owner field. The peer who owns the row is the peer that currently has exclusive rights to update the row. This peer may be the peer that modified the row most recently. In some cases, the peer who owns the row may be the peer who is assigned the row (e.g., by some algorithm, system administrator, or otherwise).

When a peer tries to modify (e.g., update or delete) a row, if the peer is the owner of the row, the modification is allowed. Otherwise, the peer may send an access token request to the peer that is the owner of the row. In one embodiment, this request may be sent via the mechanism used to replicate data in the databases. For example, a request may be placed into a log that is replicated, published, or otherwise provided to peers throughout the topology. In another embodiment, the request may be sent directly to the owning peer via conflict prevention components of the requesting and owning peers.

The owning peer may grant a request by updating the owner field in the row to match the identifier associated with the requesting peer. If multiple peers concurrently send access token requests to the owning peer, the owning peer may determine which peer to make the new owner of the row and may write an identifier corresponding to the determined peer into the owner field. In one embodiment, an access token comprises a modification to the owner field of the row, where the modification indicates a new peer that is allowed to modify the row. In the presence of multiple concurrent requests, the owning peer may use any of a number of policies to select the next owner of the row. One exemplary policy is to grant ownership to the first peer that sent the request. Based on the teachings herein, however, those skilled in the art may recognize many other suitable policies for determining the next owner of the row.

The selected new owner peer may receive notification that it is the new owner by the row being replicated to the database associated with the new owner. After receiving this notification, the peer may modify the row.

It is possible that a peer will receive an access token request for a row for which the peer is not the owner. This may occur, for example, if the requesting peer does not have the latest owner information for the row due to replication latency. In this case, the peer receiving the request may simply not respond to the request. After the row having the correct ownership information is replicated to the requesting peer, the requesting peer may then send a request to the peer indicated by the row.

In some peer-to-peer replication implementations, each peer may be in charge of certain parts of a table, and modifications to these parts of the table may be made through the peer in most cases. In these cases, most modifications to a row may be made without a request for an access token, thus avoiding some overhead. Occasionally, a peer may seek to modify a row owned by a different peer. Before the modification is made, the row's owner is changed to the peer. As long as the original owner attempts to modify the row again, the original ownership may be restored.

When a user program tries to modify a row on a peer, if the peer is not the owner of the row, an error like “access token pending” may be raised so that a transaction lock on the row is released and the user transaction may be aborted. In addition, an access token request may be sent to the row owner via a separate system transaction, which commits independently from the user transaction. The transaction lock on the row needs to be released, so that when the access token is granted and received, the owner field of this row may be updated to the peer's identifier. After the user program catches this error, it can retry the data manipulation language (DML) command or retry the aborted transaction after a timeout.

When a new peer joins the topology, tables on the new peer may be initialized by restoring the tables from a backup, installing snapshots of the table, or through some other mechanism. To assign ownership to certain parts of the tables, ownership tagging may be performed by a procedure (e.g., a stored procedure) that updates the owner fields of selected rows to the identifier of the new peer. This procedure may be replicated to and executed on other peers of the topology to broadcast the assignment of the rows to the new peer. As the topology changes, ownership may be re-distributed among peers via this same mechanism.

To fully assign ownership to a new peer, ownership tagging needs to update all involved rows. This may take more time than is desired. Sometimes this mechanism of assigning ownership needs to be avoided or delayed. For example, when a peer is taken offline, another peer needs to be assigned to take the ownership of the rows originally owned by the peer being taken offline. In order to make those rows available for modification immediately, instead of using ownership tagging to update the rows, an entry may be added into an ownership mapping table. The entry may map an old peer identifier to a new peer identifier, meaning that if the owner field of a row is the old peer ID, the effective owner of the row is the new peer. This mapping table is replicated in all peers and kept synchronized among them. With this mapping table, ownership tagging for involved rows may be finished lazily along with user DML commands.

There are five different types of conflicting manipulations: update-update, update-delete, delete-update, delete-delete, and insert-insert. The mechanism described above prevents all types of conflicting manipulations except insert-insert. When a peer tries to insert a row, the row may not yet have an owner because the row does not exist yet. If two peers concurrently try to insert two rows with the same key, an insert-insert conflict may occur. Following are some exemplary ways of preventing insert-insert conflicts:

1. In one example, each table may be assigned only one access token for insert. This access token for insert is sometimes referred to herein as an insert token. In order to insert a row, the peer trying to insert the row first obtains the insert token from the current holder. The knowledge of the current holder of the insert token may be maintained globally (e.g., in a replicated data structure). There may be concurrent inserts on multiple peers. To avoid “throttling” of the insert token requesting/granting and to avoid starving a peer, when a peer gets the insert token, the peer may hold the insert token for a pre-defined period before the peer transfers the insert token to another peer. This mechanism for preventing insert-insert conflicts serializes inserts among all peers.

2. In another example, each peer may be assigned certain key ranges, where different peers are assigned different key ranges. The knowledge of key range assignments may be maintained globally on all peers (e.g., in a replicated data structure). Each key range may be associated with an insert token. In order to insert a row in a particular key range, the peer trying to insert the row may first obtain, if needed, the insert token from the corresponding key range owner. After insertion, the insert token may be returned to the owner. In implementations where the inserting peer is most often the same as the key range owner, the average traffic to request the access token may be modest.

3. In another example, a fake owner peer ID may be calculated. One exemplary method for determining a fake owner is by performing a hash function on a key that would be generated for the inserted row and then mapping the hashed value to an existing peer ID. The peer seeking to insert a row may then contact the fake owner peer to request the insert token. If the fake owner peer has a row with the same key, the insert token request is denied and the existing row's key and “owner” field are replicated back to the requester peer. The requesting peer may then return an error to a user such as “duplicate keys.”

If the fake owner peer does not have a row with the same key, the insert token request may be granted by inserting into the table a stub row which contains the key and the owner field with the value of the requester peer's ID. This stub row is then replicated back to the requester peer to notify the requesting peer of the insert token being granted. Note that a stub row is not counted as a real user data row, but exists to prevent conflicting inserts.

The above examples of preventing insert-insert conflicts are not intended to be all-inclusive or exhaustive. Based on the teachings herein, those skilled in the art may recognize many other mechanisms for obtaining this functionality without departing from the spirit or scope of aspects of the subject matter described herein.

Although the environment described above includes various numbers of each of the entities and related infrastructure, it will be recognized that more, fewer, or a different combination of these entities and others may be employed without departing from the spirit or scope of aspects of the subject matter described herein. Furthermore, the entities and communication networks included in the environment may be configured in a variety of ways as will be understood by those skilled in the art without departing from the spirit or scope of aspects of the subject matter described herein.

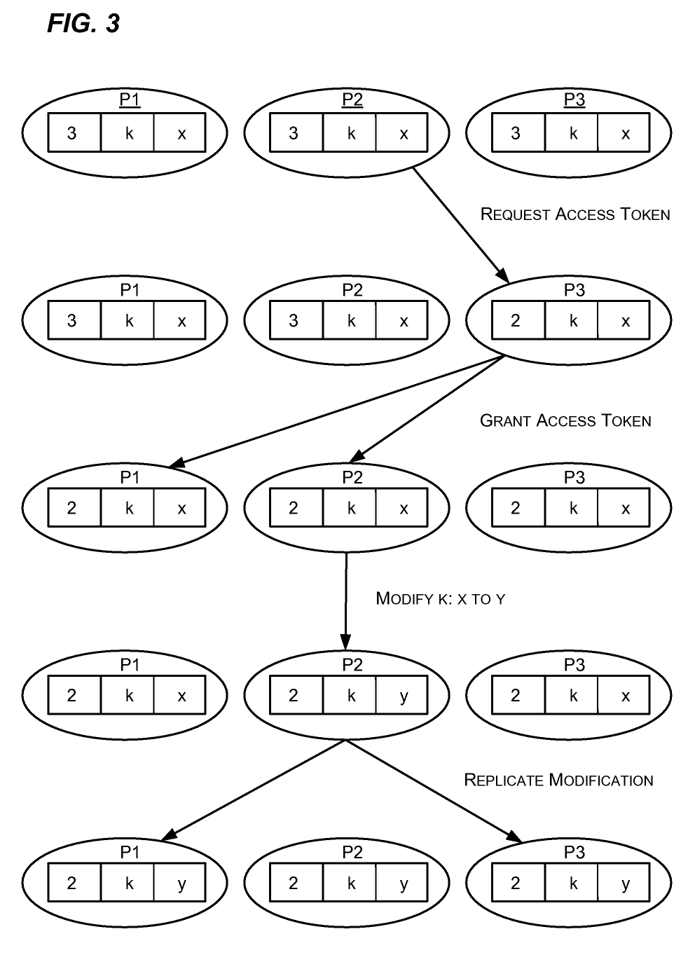

FIG. 3 is a block diagram illustrating exemplary actions involved in modifying data in accordance with aspects of the subject matter described herein. For simplicity of explanation, the methodology described in conjunction with FIG. 3 is depicted and described as a series of acts. It is to be understood and appreciated that aspects of the subject matter described herein are not limited by the acts illustrated and/or by the order of acts. In one embodiment, the acts occur in an order as described below. In other embodiments, however, the acts may occur in parallel, in another order, and/or with other acts not presented and described herein. Furthermore, not all illustrated acts may be required to implement the methodology in accordance with aspects of the subject matter described herein. In addition, those skilled in the art will understand and appreciate that the methodology could alternatively be represented as a series of interrelated states via a state diagram or as events.

FIG. 3 illustrates three peers P1, P2, and P3 and a data structure that is replicated on the three peers. The data structure includes an ownership field (the first field that includes a “3”), a key field (the second field that includes a “k”), and a value field (the third field that includes an “x”). When a requesting peer (e.g., peer P2) wants to modify the data structure, the peer first examines the data structure to determine the owner peer (e.g., peer P3) that has rights to update the data structure.

The requesting peer then sends a request for an access token to the owner peer. The owner peer responds to this request by modifying the data structure (e.g., by changing the ownership field) to indicate that the requesting peer is now the owner of the data structure. This modification is then replicated to the other peers (e.g., peers P1, and P2).

After the requesting peer receives the access token (e.g., in the form of a modification to the ownership field of the data structure), the requesting peer may then modify the data structure as desired (e.g., by changing “x” to “y”). This modification is then replicated to the other peers (e.g., peers P1 and P3).

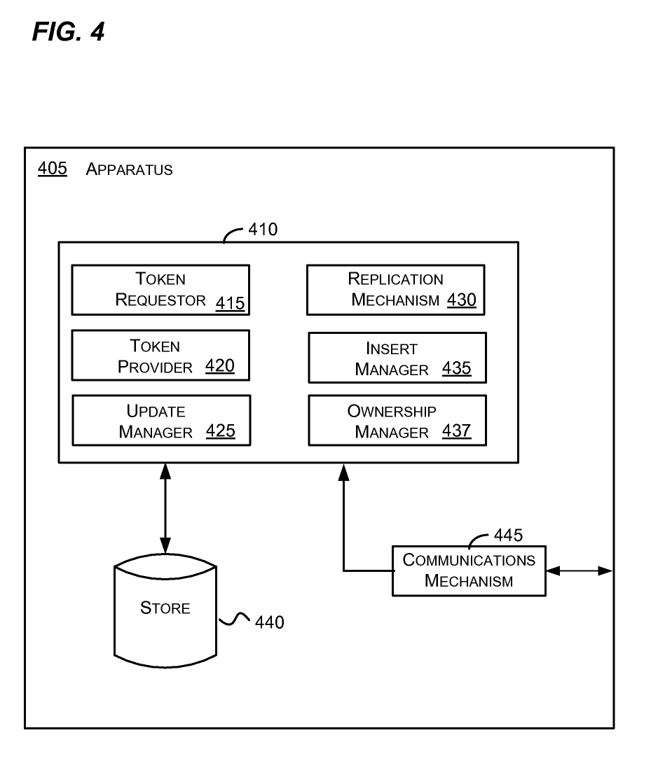

FIG. 4 is a block diagram that represents an apparatus configured as a peer in accordance with aspects of the subject matter described herein. The components illustrated in FIG. 4 are exemplary and are not meant to be all-inclusive of components that may be needed or included. In other embodiments, the components and/or functions described in conjunction with FIG. 4 may be included in other components (shown or not shown) or placed in subcomponents without departing from the spirit or scope of aspects of the subject matter described herein. In some embodiments, the components and/or functions described in conjunction with FIG. 4 may be distributed across multiple devices.

Turning to FIG. 4, the apparatus 405 may include conflict prevention components 410, a store 440, and a communications mechanism 445. The conflict prevention components 410 may include a token requester 415, a token provider 420, and update manager 425, a replication mechanism 430, an insert manager 435, and an ownership manager 437.

The communications mechanism 445 allows the apparatus 405 to communicate with other entities shown in FIG. 2. The communications mechanism 445 may be a network interface or adapter 170, modem 172, or any other mechanism for establishing communications as described in conjunction with FIG. 1.

The store 440 is any storage media capable of storing data. The store 440 may comprise a file system, database, volatile memory such as RAM, other storage, some combination of the above, and the like and may be distributed across multiple devices. The store 440 may be external, internal, or include components that are both internal and external to the apparatus 405.

The token requester 415 is operable to obtain an access token for a data structure from the owner peer if the data structure is not owned by a peer hosted on the apparatus. For example, referring to FIG. 3, the token requester 415 of peer P2 would request an access token from the owner peer P3 before modifying the data structure.

The token provider 420 is operable to provide an access token to a requesting peer if the data structure is owned by the peer hosted on the apparatus. For example, referring to FIG. 3, the token provider 420 of peer P3 is operable to provide the access token to the requesting peer P2 as the peer P3 is the owner of the data structure. Returning to FIG. 4, when an owner peer receives requests from multiple requesting peers, the token provider 420 may be further operable to select one of the requesting peers to which to provide the access token.

The update manager 425 is operable to update a replica of the data structure (e.g., a row) that is replicated on a plurality of peers. The replica may be stored, for example, in the store 440.

The replication mechanism 430 is operable to participate in replicating the data structure across the peers. This may be done by transmitting the data structure, changes to the data structure, actions involved in changing the data structure, or in a variety of other ways as will be understood by those skilled in the art. For example, after the update manager 425 updates a data structure, the modification to the replica may be replicated to one or more other peers via the replication mechanism 430.

The insert manager 435 may be operable to perform various actions as described previously with respect to insert-insert conflicts so that a conflict does not occur in inserting new data structures. For example, the insert manager 435 may be operable to generate a key with which a new data structure is to be created. The insert manager 435 may generate this key based on ranges of keys that have been assigned to peers.

The ownership manager 437 may be operable to determine an owner peer of a data structure based on information included in the replica of the data structure. For example, referring to FIG. 3, the ownership manager 437 of peer P2 may determine that the owner of the data structure is peer P3 based on the “3” in the data structure.

Returning to FIG. 4, the ownership manager 437 may be further operable to assume ownership of one or more data structures owned by another peer that is being removed (e.g., shut down) from the plurality of peers that are replicated the data structure. As mentioned previously, in one example, this may be done by executing a procedure (e.g., a stored procedure) that updates, for each of the one or more data structures, an ownership field. The ownership field is hidden from applications executing on the peer hosted on the apparatus 405 but is visible to a database managing system tasked with preventing conflicting updates to the data structures. The ownership manager 437 may provide this procedure (e.g., via the replication mechanism 430) to other of the peers for execution thereon so that the ownership change is replicated on the peers.

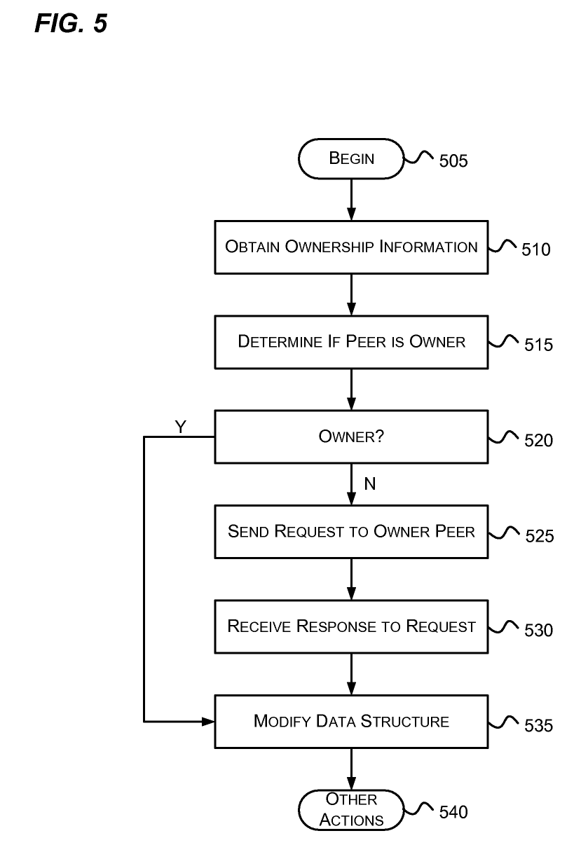

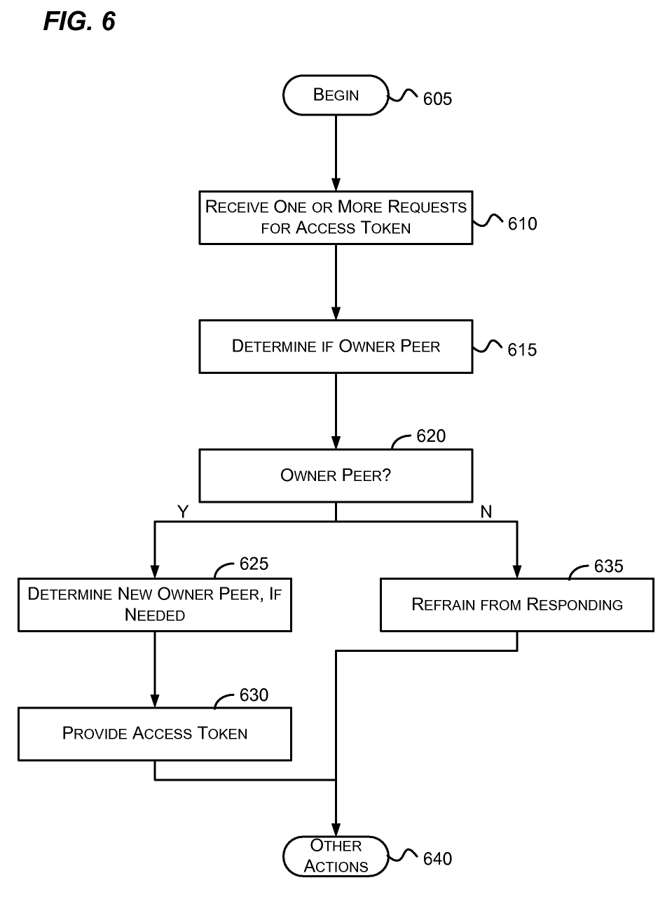

FIGS. 5-6 are flow diagrams that generally represent actions that may occur in accordance with aspects of the subject matter described herein. For simplicity of explanation, the methodology described in conjunction with FIGS. 5-6 is depicted and described as a series of acts. It is to be understood and appreciated that aspects of the subject matter described herein are not limited by the acts illustrated and/or by the order of acts. In one embodiment, the acts occur in an order as described below. In other embodiments, however, the acts may occur in parallel, in another order, and/or with other acts not presented and described herein. Furthermore, not all illustrated acts may be required to implement the methodology in accordance with aspects of the subject matter described herein. In addition, those skilled in the art will understand and appreciate that the methodology could alternatively be represented as a series of interrelated states via a state diagram or as events.

FIG. 5 is a flow diagram that generally represents actions that may occur on a peer seeking to modify a data structure in accordance with aspects of the subject matter described herein. At block 505, the actions begin.

At block 510, ownership information of a data structure is obtained. For example, referring to FIGS. 3 and 4, the ownership manager 437 determines that peer P3 owns the data structure. In one embodiment, owning the data structure indicates that the owner peer has exclusive rights to update the data structure. The data structure may correspond to a row of a relational database. The ownership information (e.g., an identifier of the owner peer) may be encoded in a hidden column that is hidden from applications accessing the row but visible to a database management system that provides access to the row. The database management system may be tasked at least in part with preventing conflicting updates to the data structure.

At block 515, a determination is made as to whether the peer is the owner peer. For example, referring to FIG. 3, the peer P2 determines that the data structure is owned by the peer P3.

At block 520, if the peer is the owner peer, the actions continue at block 535; otherwise, the actions continue at block 525. For example, referring to FIG. 3, since the peer P2 does not own the data structure, the peer P2 needs to request the access token from the peer P3.

At block 525, a request for the access token is sent to the owner peer. For example, referring to FIG. 3, the peer P2 sends a request for the access token to the peer P3. As mentioned previously, in one embodiment, this request may be sent by encoding the request into a log through which the database of the requester peer is published to the owner peer. In another embodiment, this request may be sent by contacting the owner peer and sending the request directly to the owner peer. Based on the teachings contained herein, those skilled in the art may recognize many other mechanism that may also be used for sending the request without departing from the spirit or scope of aspects of the subject matter described herein.

At block 530, a response to the request is received. For example, referring to FIG. 3, the peer P3 grants the access token by modifying the owner field of the data structure to refer to the peer P2. This modification is then replicated to the peers replicating the data structure.

At block 535, the replica of the data structure is modified. For example, referring to FIG. 3, the peer P2 changes the value “x” to “y” in the replica of the data structure that is maintained by P2. This update is then replicated to the peers P1 and P3. Note that if the peer is the owner peer, the replica of the data structure may be modified without sending a request for the access token to another peer.

At block 540, other actions, if any, are performed.

In one embodiment, where an owner peer controls data structure inserts, the owner peer may insert a stub data structure that indicates that the requesting peer is the owner peer as indicated previously.

FIG. 6 is a flow diagram that generally represents actions that may occur on a peer receiving a token access request in accordance with aspects of the subject matter described herein. At block 605, the actions begin.

At block 610, the peer receives one or more requests for an access token for a data structure. For example, referring to FIG. 2, the peer 208 may receive requests for an access token from the peers 205 and 207. This access token may relate to a data structure that the requesting peers seek to update that is replicated on the peers 207-211. As mentioned previously, the access token may comprise an identifier that indicates which peer owns the data structure and is allowed to update the data structure.

At block 615, the peer determines whether it is the owner peer of the data structure. For example, referring to FIG. 4, the ownership manager 437 determines whether the peer is the owner of the data structure associated with the request. As mentioned previously, it is possible that the peer is not the owner of the data structure as there may be latencies in replicating new ownership information.

At block 620, if the peer is the owner peer, the actions continue at block 625; otherwise, the actions continue at block 635.

At block 625, the new owner peer is determined, if needed. For example, if the peer 208 receives access token requests from the peers 205 and 207, the peer 208 may need to determine which of these peers is to receive the access token and become the new owner of the data structure. If only one peer has requested the access token, then this action may be omitted.

At block 630, the access token is provided to the new owner peer. For example, referring to FIG. 2, the peer 208 provides the access token to the peer 205 by changing the ownership field in the data structure and allowing the data structure to be replicated out to the other peers.

At block 635, the peer refrains from responding to the request. For example, referring to FIG. 2, if the peer 208 determines that it is not the owner of the data structure, the peer 208 may simply refrain from responding to the request. In another embodiment, the peer may inform the requesting peers that the peer is not the owner.

At block 640, other actions, if any, are performed.

As can be seen from the foregoing detailed description, aspects have been described related to conflict prevention. While aspects of the subject matter described herein are susceptible to various modifications and alternative constructions, certain illustrated embodiments thereof are shown in the drawings and have been described above in detail. It should be understood, however, that there is no intention to limit aspects of the claimed subject matter to the specific forms disclosed, but on the contrary, the intention is to cover all modifications, alternative constructions, and equivalents falling within the spirit and scope of various aspects of the subject matter described herein.

What is claimed is:

1. A method implemented at least in part by a computer, the method comprising:
obtaining information in a replica of a data structure that is replicated on multiple peers, the information indicating an owner peer that has rights to update the data structure;
determining if a peer is the owner peer via the information;
if the peer is not the owner peer, performing actions, comprising:
sending a request for an access token to the owner peer;
receiving a response to the request, the response providing the access token; and
modifying the replica of the data structure after the response is received.

2. The method of claim 1, wherein the data structure corresponds to a row of a relational database and wherein information is included in a hidden column of the row, the hidden column being hidden from applications accessing the data structure but being visible to a database management system.

3. The method of claim 1, wherein sending a request for an access token to the owner peer comprises encoding the request into a log through which a database of a requester peer is published to the owner peer.

4. The method of claim 1, wherein sending a request for an access token to the owner peer comprises contacting the owner peer and sending the request.

5. The method of claim 1, wherein sending a request for an access token to the owner peer comprises a requesting peer sending the request and wherein receiving the response comprises receiving a modification to the replica of the data structure via a replication mechanism that replicates the modification to the multiple peers, the modification indicating that the requesting peer is now the owner peer and is allowed to modify the data structure.

6. The method of claim 1, wherein the access token comprises a field of the data structure that is hidden from applications accessing the replica of the data structure but visible to a database management system that is tasked at least in part with preventing conflicting updates to the data structure, the field encoding an identifier associated with the owner peer.

7. The method of claim 1, further comprising if the peer is the owner peer, modifying the replica of the data structure without sending a request for the access token to another peer.

8. The method of claim 1, wherein the response includes a stub that indicates that the peer is the owner peer, the stub being inserted by a peer that controls inserts into the data structure.

9. A computer storage medium having computer-executable instructions, which when executed perform actions, comprising:
receiving, at a receiving peer, a request for an access token from a requesting peer that is one of a plurality of peers that replicate data, the access token relating to a data structure that the requesting peer seeks to update, the data structure being replicated on the peers, the access token allowing updates to the data structure;
determining if the receiving peer is an owner peer that has exclusive rights to update the data structure; and
if the receiving peer is the owner peer, providing the access token.

10. The computer storage medium of claim 9, further comprising receiving another request for the access token from another requesting peer and determining which of the requesting peers to which to provide the access token.

11. The computer storage medium of claim 9, further comprising if the receiving peer is not the owner peer, refraining from responding to the request.

12. The computer storage medium of claim 9, wherein providing the access token comprises modifying a field of the data structure to indicate that the requesting peer is now the owner of the data structure and providing an indication of the field as modified to at least one of the plurality of peers that replicate data.

13. The computer storage medium of claim 12, wherein the field is hidden from applications that access the data structure but is visible to a database management system tasked at least in part with preventing conflicting updates to the data structure, the field encoding an identifier associated with the owner peer.

14. The computer storage medium of claim 12, wherein the data structure corresponds to a row of a relational database and wherein the data structure includes the information that indicates the owner peer in a hidden column of the row.

15. In a computing environment, an apparatus, comprising:
an update manager operable to update a replica of a data structure that is replicated on a plurality of peers;
an ownership manager operable to determine an owner peer of the data structure based on information included in the replica of the data structure, the owner peer having rights to update the data structure;
a replication mechanism operable to participate in replicating the data structure across the peers; and
a token requester operable to obtain an access token from the owner peer before the update manager updates the replica of the data structure if the data structure is not owned by a peer hosted on the apparatus.

16. The apparatus of claim 15, further comprising a token provider operable to provide the access token to a requesting peer if the data structure is owned by the peer hosted on the apparatus.

17. The apparatus of claim 16, wherein the token provider is further operable to select the requesting peer from a plurality of peers that have requested the access token from the peer hosted on the apparatus.

18. The apparatus of claim 15, further comprising an insert manager that is operable to generate a key with which a new data structure is to be created, the insert manager generating the key based on ranges of keys that have been assigned to the peers.

19. The apparatus of claim 15, wherein the ownership manager is further operable to assume ownership of one or more data structures owned by another peer that is being removed from the plurality of peers that are replicating the data structure.

20. The apparatus of claim 19, wherein the ownership manager is operable to assume ownership of one or more data structure owned by another peer by executing a procedure that updates, for each of the one or more data structures, a field that is hidden from applications executing on the peer hosted on the apparatus, the owner manager being further operable to provide the procedure to other of the peers for execution thereon.
